(19) United States
(12) Patent Application Publication
(10) Pub. No.: US 2006/0082920 A1
(43) Pub. Date: Apr. 20, 2006

(54) Recording/reproducing apparatus including disk recording medium and method of protecting disk recording medium

(76) Inventor: Koichi Horiuchi, Nara (JP)

Correspondence Address: RATNERPRESTIA, P.O. BOX 980, VALLEY FORGE, PA, 19482, US

(21) Appl. No.: 11/232,751

(22) Filed: Sep. 22, 2005

(30) Foreign Application Priority Data
Oct. 15, 2004 (JP) 2004-301151

(51) Int. Cl. G11B 21/02; G11B 5/00; H04N 7/52; H04N 7/26

(52) U.S. Cl. 360/75; 360/8; 386/95; 386/109

(57) ABSTRACT

A recording/reproducing apparatus includes a disk recording medium, a head for accessing the disk recording medium, an escape zone to which the head escapes, a controller operable to control the head, a sensor for detecting vibration or drop of the disk recording medium, and an actuator for moving the head from the disk recording medium to the escape zone based on a detection result of the sensor. The controller is operable to record first data in a first region of the disk recording medium with the head and to record second data in a second region of the disk recording medium with the head. The second region is located farther from the escape zone than the first region. The second data has an attribute different from an attribute of the first data. This recording/reproducing apparatus can protect the disk recording medium from shock even when the shock occurs in various circumstances.

### FIELD OF THE INVENTION

The present invention relates to a recording/reproducing apparatus for recording and reproducing moving pictures on/from a disk recording medium such as a hard disk and a method of protecting the disk recording medium.

### BACKGROUND OF THE INVENTION

The recent development of image compression techniques, such as MPEG, has been enabling moving pictures and still pictures to be handled as digital data. A recording medium, e.g. an optical disk, such as DVD and a hard disk, has had a large capacity, and accordingly such a random accessible recording medium has been used for recording moving pictures and still pictures as digital data. A DVD recorder, a hard disk recorder, and a hybrid recorder including both a DVD drive and a hard disk are random accessible and easily used, thus spreading rapidly.

A portable moving picture recording/reproducing apparatus, such as a digital still camera and a digital camcorder, has employed a disk recording medium, a random accessible recording medium. Since the hard disk has an advantage, such as a small size and a large capacity while not being detachable, the hard disk have been used as a recording medium in a portable type moving picture recording/reproducing apparatus which is required to be portable and to record and reproduce large data, such as moving pictures.

The hard disk has a problem, as a recording medium used for a portable type moving picture recording/reproducing apparatus. The hard disk is weak to shock accompanying vibration or drop, and data recorded in it may be destroyed by the shock. The hard disk includes a head which moves while slightly floating from the disk and which accesses data on the disk. When the disk receives a large shock, the head may contact the disk and destroy the recorded data physically. Even if the head does not contact the disk, when the disk receives shock during the recording of data, the head may be displaced from a correct position and incorrectly overwrite another data on the data already recorded, thus destroy the data already recorded.

Conventional recording/reproducing apparatuses including disk recording media and conventional methods of protecting the disk recording media will be described below.

Japanese Patent No. 3223359 discloses an elastic member attached to a hard disk and an acceleration sensor. When the acceleration sensor detects shock, a head is moved from a disk recording medium to an escape zone before the shock reaches the hard disk. The elastic member causes the shock to delay. This protects the disk recording medium from the shock.

Japanese Patent No. 3441668 discloses an acceleration sensor detecting drop of components in three directions. When an acceleration detected continues to be appropriately zero for a predetermined time, the acceleration sensor judges that a recording medium is dropping. While the recording medium is dropping, the head escapes from a disk recording medium to a head escape zone. Thus, the head escapes to such a safe position before receiving shock due to collision, thereby protecting the disk recording medium from the shock.

Japanese Patent Laid-Open Publication No. 2001-143371 discloses four apparatuses.

The first apparatus includes a memory for temporarily storing data. Except the time data are recorded from the memory in a disk recording medium, the head escapes from the disk recording medium to an escape zone. Since this apparatus can record moving picture data on the disk recording medium faster than the actual time of the moving picture data, the time during which the apparatus does not record data can be longer than the time during which the apparatus records data in disk recording medium. When data are not recorded in the disk recording medium, the head escapes to an escape zone, thereby reducing the ratio of an unsafe time. This operation reduces the possibility that data in the disk recording medium is destroyed.

The second apparatus includes a switch with which a user instructs data to be recorded. When the user releases himself/herself from the switch, the apparatus allows a head to escape from a disk recording medium to an escape zone. In this apparatus, the head escapes to the escape zone between the detection of the start of dropping and the occurrence of shock due to collision, thereby protecting the disk recording medium from the shock.

The third apparatus includes a device for detecting that a user holds the apparatus by a hand of the user. When it is detected that the user's hand removed from the apparatus, the apparatus allows the head to escape from a disk recording medium to an escape zone. In this apparatus, the head escapes to the escape zone between the detection of the start of dropping and the occurrence of shock due to collision, thereby protecting the disk recording medium from the shock.

The fourth apparatus includes a device for capturing an image of an object and a device for detecting a motion vector of the captured image. The apparatus judges that the apparatus is dropping when the detected motion vector represents a punning operation accompanying drop, and allows a head to escape from a disk recording medium to an escape zone. In this apparatus, the head escapes to such safe position between the detection of the start of the dropping and the occurrence of shock due to collision, thereby protecting the disk recording medium from the shock.

The above-mentioned conventional apparatuses may not be able to protect the disk recording mediums from shock. These conventional apparatuses protect the disk recording medium from shock by allowing the head to escape to such safe positions while the elastic member have the shock delay, or while the apparatus detects that the apparatus is dropping and then shock due to collision occurs, or while the apparatus detects the start of dropping and then shock due to collision occurs. However, portable type moving picture recording/reproducing apparatuses are used in various conditions, hence receiving shocks occurring in various situations. For example, the shock may be very strong, or the time to collision may be very short. In such cases, since the period from the time of the start of the escape of the head to the time when the shock is transmitted to the head or the disk recording medium is short, the head may not be moved to the safe position, and the disk recording medium cannot be protected from the shock.

### SUMMARY OF THE INVENTION

A recording/reproducing apparatus includes a disk recording medium, a head for accessing the disk recording medium, an escape zone to which the head escapes, a controller operable to control the head, a sensor for detecting vibration or drop of the disk recording medium, and an actuator for moving the head from the disk recording medium to the escape zone based on a detection result of the sensor. The controller is operable to record first data in a first region of the disk recording medium with the head and to record second data in a second region of the disk recording medium with the head. The second region is located farther from the escape zone than the first region. The second data has an attribute different from an attribute of the first data.

This recording/reproducing apparatus can protect the disk recording medium from shock even when the shock occurs in various circumstances.

### BRIEF DESCRIPTION OF THE DRAWINGS

FIG. 1 is a block diagram of a recording/reproducing apparatus in accordance with Exemplary Embodiment 1 of the present invention.

FIG. 2 is a block diagram of a hard disk of the recording/reproducing apparatus in accordance with Embodiment 1.

FIGS. 3A and 3B show operations of the hard disk recording data in accordance with Embodiment, respectively.

FIGS. 4A and 4B show operations of the hard disk reproducing data in accordance with Embodiment 1.

FIG. 5 is a plan view of a magnetic disk of the hard disk in accordance with Embodiment 1.

FIG. 6 is a plan view of a magnetic disk of a hard disk of a recording/reproducing apparatus in accordance with Exemplary Embodiment 2 of the invention.

### DETAILED DESCRIPTION OF THE PREFERRED EMBODIMENTS

### Exemplary Embodiment 1

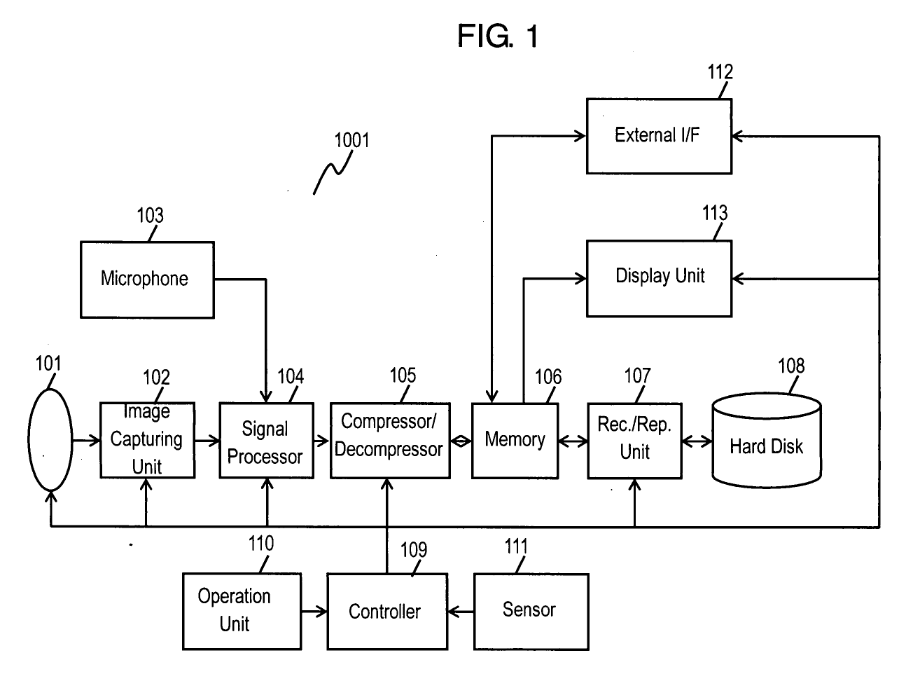

FIG. 1 is a block diagram of recording/reproducing apparatus 1001 in accordance with Exemplary Embodiment 1 of the present invention. Recording/reproducing apparatus 1001 includes lens 101, image-capturing unit 102, microphone 103, signal processor 104, compressor/decompressor 105, memory 106, recording/reproducing unit 107, hard disk 108, controller 109, operation unit 110, sensor 111, external interface (I/F) 112, and display unit 113. Display unit 113 includes a loud speaker and a display, such as LCD.

Operation unit 110 includes, for example, an operation mode switch, a picture recording switch, a four-direction switch, and a determination switch, and activated by a user. The operation mode switch instructs the apparatus to initiate operation modes including a moving picture recording mode, a still picture recording mode, and a reproducing mode. The picture recording switch instructs the apparatus of the start and stop of picture recording. The four-direction switch instructs the apparatus of up, down, left, and right directions. The determination switch instructs the apparatus of a determination result. Operation unit 110 may be implemented by operation icons displayed on a display, such as a touch panel, instead of the above-mentioned switches.

An operation of recording/reproducing apparatus 1001 recording a moving picture after the operation mode switch of operation unit 110 is switched to the moving picture recording mode will be described below. Upon detecting that the picture recording switch of operation unit 110 is pressed, controller 109 starts the recording of moving pictures. Light from an object passes through lens 101, forms an image on image-capturing unit 102, such as CCD, and captured as an image of the object. Sound from the object is captured by microphone 103. Signal processor 104 performs camera signal processing of moving pictures to an image captured by image-capturing unit 102 so as to provide moving picture data. The moving picture data is output together with audio data produced from the sound from microphone 103. Compressor/decompressor 105 multiplexes and compresses the moving picture data and the audio data in a moving picture compression format, such as MPEG2, so as to form compressed moving picture data. The compressed moving picture data is temporarily stored in memory 106. When a predetermined amount of the compressed moving picture data are stored in memory 106, recording/reproducing unit 107 reads the compressed moving picture data from memory 106 and records the data on hard disk 108. Upon detecting that the picture recording switch of operation unit 110 is pressed again, controller 109 stops the recording of the moving picture. At this moment, compressed moving picture data remaining in memory 106 are read from memory 106 and recorded in hard disk 108 by recording/reproducing unit 107.

Next, an operation of recording/reproducing apparatus 1001 recording a still picture after the operation mode switch of operation unit 110 is switched to the still picture recording mode will be described below. Upon detecting that the picture recording switch of operation unit 110 is pressed, controller 109 executes the recording of still pictures. Light from an object passes through lens 101, forms an image on image-capturing unit 102, and captured as a picture of an object. Signal processor 104 performs camera signal processing as still pictures to the image captured by image-capturing unit 102 so as to output still picture data. Compressor/decompressor 105 compresses the still picture data in a still picture compression format, such as JPEG, and temporarily stores the still picture data in memory 106 as compressed still picture data. Recording/reproducing unit 107 reads the compressed still picture data from memory 106 and records the data in hard disk 108.

Upon controller 109 detecting that the operation mode switch of operation unit 110 is set to the reproducing mode, display unit 113 displays information for allowing the user to select from the compressed moving picture data and the compressed still picture data recorded in hard disk 108.

The four-direction switch and the determination switch of operation unit 110 cause controller 109 to detect that one of the compressed moving picture data is selected. Then, recording/reproducing unit 107 reads a predetermined amount of portion of the compressed moving picture data recorded in hard disk 108 and temporarily stores the portion in memory 106. Compressor/decompressor 105 reads the portion of the compressed moving picture data stored in memory 106, decompresses the portion so as to reproduce an image and sound, and stores the image and sound in memory 106. Display unit 113 reads the image and sound stored in memory 106 and outputs them from the display and the loudspeaker, respectively. When all the compressed moving picture data stored in memory 106 are read out and no compressed moving picture data remains in memory 106, recording/reproducing unit 107 reads a predetermined amount of subsequent portion of the compressed image data recorded in hard disk 108 and temporarily stores them in memory 106. Upon detecting that the determination switch of operation unit 110 is pressed again, controller 109 stops the reproduction of moving pictures.

When the four-direction switch and the determination switch of operation unit 110 causes controller 109 to detect that compressed still picture data is selected, recording/reproducing unit 107 reads a predetermined amount of data including compressed still picture data recorded in hard disk 108 and temporarily stores the data in memory 106. Compressor/decompressor 105 reads compressed still picture data stored in memory 106, decompresses the data so as to form a still picture image, and stores the still picture image in memory 106. Display unit 113 reads the still picture image stored in memory 106 and displays it on the display. Then, upon the four-direction switch of operation unit 110 causes controller 109 to detect that a user instructs the apparatus of frame-by-frame advance, compressor/decompressor 105 reads subsequent compressed still picture data stored in memory 106, decompresses the data so as to form a still picture image, and stores the still picture image in memory 106. Display unit 113 reads the still picture image stored in memory 106 and displays the image on the display. When all the compressed still picture data stored in memory 106 are read out and no still picture data remains in memory 106, recording/reproducing unit 107 reads a predetermined amount of data including subsequent compressed still picture data recorded in hard disk 108 and temporarily stores the data in memory 106.

External I/F 112 may be a network, such as a USB, a wireless LAN, or a mobile telephone network, or a slot for a removable recording medium, such as a memory card. External I/F 112 is used to transfer data between the outside of recording/reproducing apparatus 1001 and hard disk 108 via memory 106. External I/F 112 enables data other than images captured by image-capturing unit 102 to be recorded in hard disk 108. For example, recording/reproducing apparatus 1001 can be used as a portable viewer for recording in hard disk 108 television programs recorded with a DVD recorder and for reproducing the programs with display unit 113. Furthermore, the image captured by image-capturing unit 102 and recorded in hard disk 108 can be read to the outside of recording/reproducing apparatus 1001. For example, recording/reproducing apparatus 1001 can be used as a portable type camera, a peripheral device of a server. Recording/reproducing apparatus 1001 allows images recorded in hard disk 108 to be recorded in a DVD recorder as a backup, and the images from the DVD recorder is displayed on television sets.

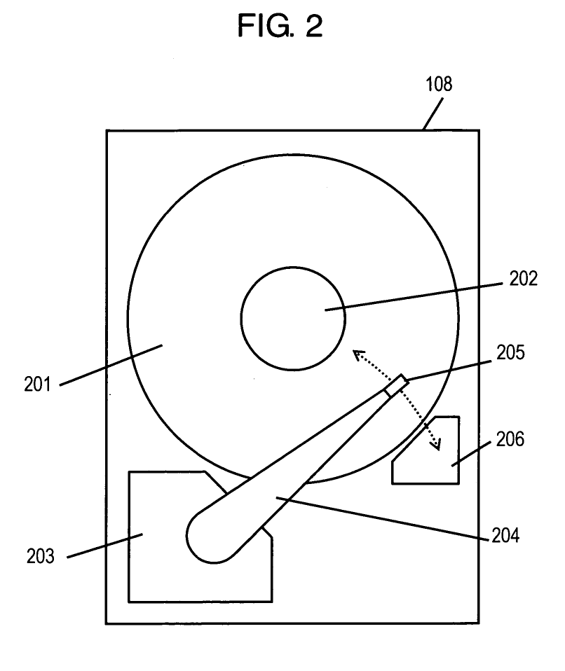

FIG. 2 is a block diagram of hard disk 108 of recording/reproducing apparatus 1001 according to Embodiment 1. Hard disk 108 includes magnetic disk 201, spindle motor 202, actuator 203, arm 204, magnetic head 205, and escape zone 206. Magnetic disk 201 rotates at high speed by spindle motor 202. Magnetic head 205 for recording data on magnetic disk 201 and reading out data recorded on magnetic disk 201 is provided at a tip of arm 204. Magnetic head 205 accesses data on magnetic disk 201. Actuator 203 swings arm 204 as to move magnetic head 205 above magnetic disk 201. Magnetic disk 201 has a rotation center and plural tracks provided as concentric circle regions. Each of the tracks has plural sectors. Actuator 203 moves magnetic head 205 to a predetermined track. When a predetermined sector of the track reaches magnetic head 205 during the rotation of magnetic disk 201, magnetic head 205 records or reproduces data, that is, accesses data.

Sensor 111, such as an acceleration sensor, detects the change in physical states, such as vibration or drop, of recording/reproducing apparatus 1001, and accordingly transmits signals to controller 109. According to the transmitted signals, controller 109 judges whether or not hard disk 108 (recording/reproducing apparatus 1001) is vibrating or dropping which causes shock. Configuration of sensor 111, a method for detecting the vibration or the dropping which causes the shock, a method for judging states, or a method for detecting the shock itself may be conventional methods. Any methods for detecting the transmission of shock before the shock is transmitted to magnetic head 205 or magnetic disk 201 of hard disk 108 may be employed.

Sensor 111 detects a physical movement, such as acceleration, vibration, or velocity, applied to hard disk 108 when recording/reproducing unit 107 accesses data recorded in hard disk 108. When controller 109 judges, based on a detection result of sensor 111, that hard disk 108 is vibrating or dropping which causes shock, recording/reproducing unit 107 stops recording and reproducing of data in/from hard disk 108. Controller 109 instruct magnetic head 205 to escape from a position where head 205 accesses data to escape zone 206 that is apart from the magnetic disk 201. Escape zone 206 is a safe position protecting magnetic disk 201 from the shock.

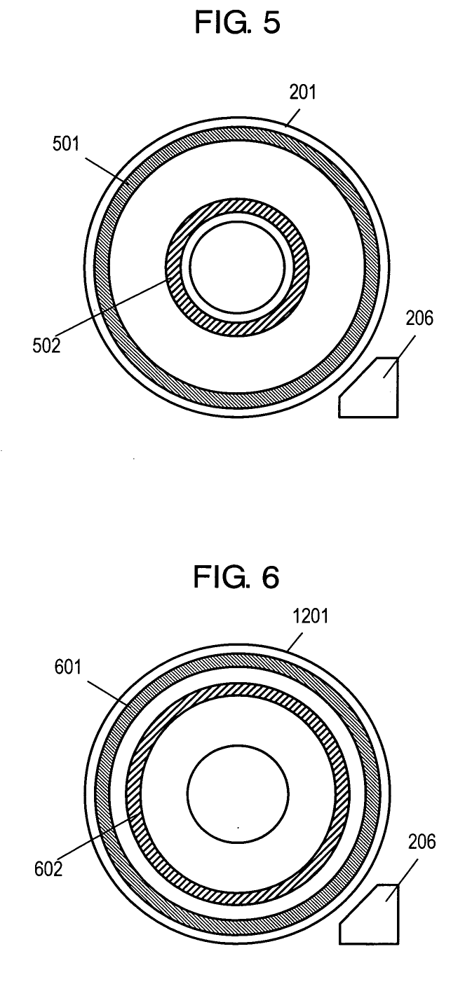

FIG. 5 is a plan view of magnetic disk 201 of hard disk 108. An operation of recording/reproducing apparatus 1001 will be described below in detail with reference to FIG. 5. Magnetic disk 201 has regions 501 and 502 thereon. Region 501 is closer to escape zone 206 than region 502. Recording/reproducing unit 107 records compressed moving picture data in region 501. Recording/reproducing unit 107 records, in region 502, compressed still picture data having an attribute different from that of the compressed moving picture data. When recording/reproducing unit 107 reproduces the compressed moving picture data recorded in hard disk 108, magnetic head 205 is positioned at region 501 which is closer to escape zone 206 than region 502 of magnetic disk 201. When recording/reproducing unit 107 reproduces the compressed still picture data recorded in hard disk 108, magnetic head 205 is positioned at region 502 which is farther from escape zone 206 than region 501.

The distance from escape zone 206 to region 501 having the compressed moving picture data recorded therein is shorter than the distance from escape zone 206 to region 502 having the compressed still picture data recorded therein. Therefore, the time for moving magnetic head 205 to escape zone 206 during the accessing of the compressed moving picture data is shorter than the time for moving magnetic head 205 to escape zone 206 during the accessing of the compressed still picture data.

An operation of recording/reproducing apparatus 1001 will be described.

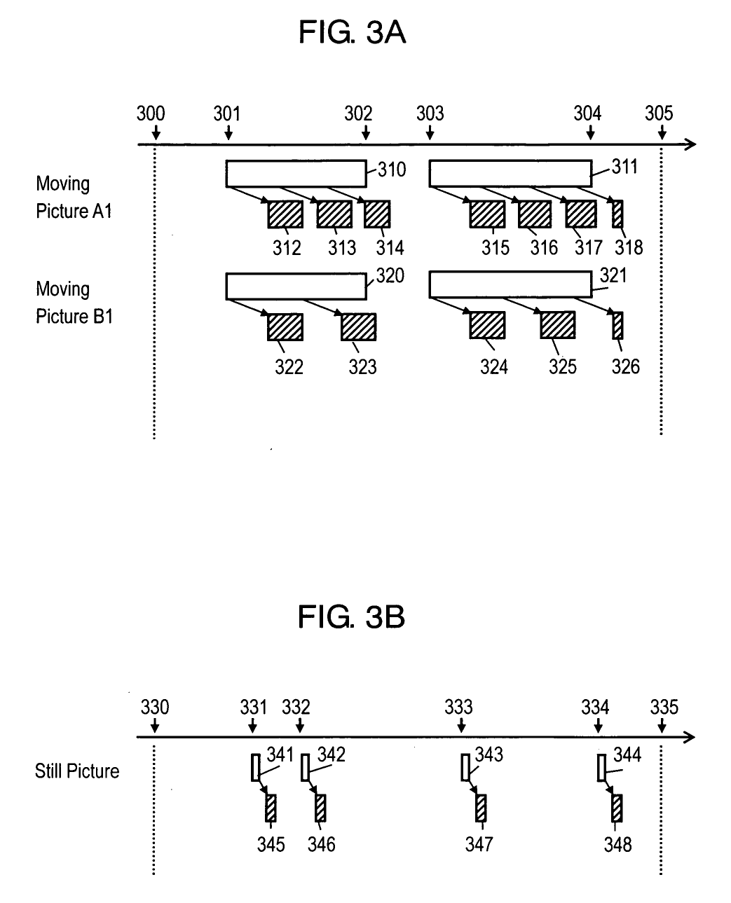

FIG. 3A shows an operation of recording/reproducing apparatus 1001 when moving picture data are recorded in hard disk 108. A user operates operation unit 110 at time points 300 to 305 while recording moving picture A1. Image-capturing unit 102 captures images of an object during periods 310 and 311. Compressed moving picture data of moving picture A1 produced from the captured images are recorded in hard disk 108 during periods 312 to 318. The user turns on recording/reproducing apparatus 1001 at time point 300 and turns it off at time point 305. Between time point 300 and time point 305, the user starts the recoding of moving picture Al at time point 301, continues the recording during period 310, and then stops the recording at time point 302. The user restarts the recoding of moving picture A1 at time point 303, continues the recording during period 311, and then stops the recording at time point 304. When a predetermined amount of data are stored in memory 106 during period 310 when the images is captured, the data in memory 106 are recorded in hard disk 108 during periods 312 to 313. Data remaining in memory 106 at time point 302 when the recording is stopped are recorded in hard disk 108 during period 314. when a predetermine amount of data are stored in memory 106 during period 311, and the data in memory 106 are recorded in hard disk 108 during periods 315 to 317. Data remaining in memory 106 at time point 304 when the recording is stopped are recorded in hard disk 108 during period 318. During periods 312 to 318 when data are recorded in hard disk 108, magnetic head 205 is positioned at magnetic disk 201.

FIG. 3B shows an operation of recording/reproducing apparatus 1001 when still picture data are recorded in hard disk 108. A user operates operation unit 110 at time points 330 to 335 while recording still pictures. Image-capturing unit 102 captures images of an object during periods 341 to 344. Compressed still picture data of still pictures produced from the captured images are recorded in hard disk 108 during periods 345 to 348. The user turns on recording/reproducing apparatus 1001 at time point 330 and turns it off at time point 335. Between time point 330 and time point 335, the user captures still pictures at time point 331 to 334. Compressed still picture data of the still pictures captured at time points 331 to 334 are stored in memory 106 during periods 341 to 344, respectively. The data stored in memory 106 are recorded in hard disk 108 during period 345 to 348. During periods 345 to 348 when the data are recorded in hard disk 108, magnetic head 205 is positioned at magnetic disk 201.

The amount of moving picture data is generally larger than that of still picture data, and the total of periods 312 to 318 is accordingly longer than the total of periods 345 to 348. That is, the time during which magnetic head 205 is positioned at magnetic disk 201 to record moving picture data is longer than the time during which magnetic head 205 is positioned at magnetic disk 201 to record still picture data.

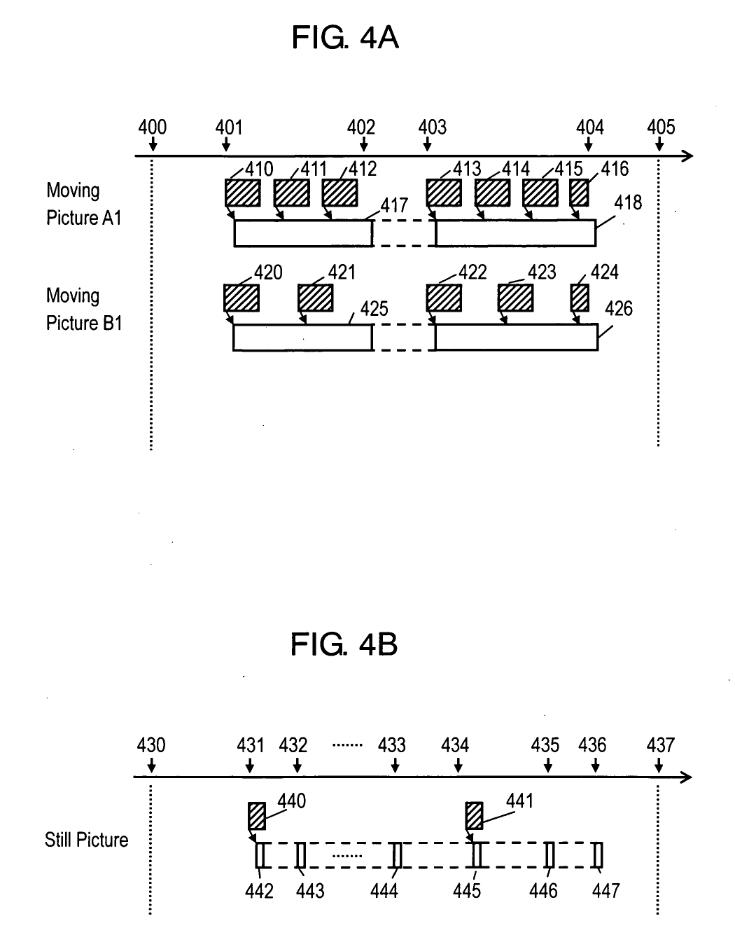

FIG. 4A shows an operation of recording/reproducing apparatus 1001 when moving picture data are reproduced from hard disk 108. A user turns on recording/reproducing apparatus 1001 at time point 400 and turns it off at time point 405. The user operates operation unit 110 at time points 400 to 405 for reproducing moving picture A1. When the user instructs the apparatus to start the reproducing through operating operation unit 110 at time point 401, recording/reproducing unit 107 reads compressed moving picture data from hard disk 108 during periods 410 to 412 and stores the data in memory 106. The compressed moving picture data read from memory 106 are decompressed by compressor/decompressor 105 and stored in memory 106 as moving picture data. The moving picture data are read from memory 106 and sequentially displayed on display unit 113 during period 417. When the user instructs the stop of reproduction by operating operation unit 110 at time point 402, recording/reproducing unit 107 stops the reading out of the compressed moving picture data from hard disk 108. Thus, period 412 ended. Thereafter, the user instructs the start of reproduction by operating operation unit 110 at time point 403, recording/reproducing unit 107 reads out compressed moving picture data from hard disk 108 during periods 413 to 416 and stored in memory 106. The compressed moving picture data read out from memory 106 are decompressed by compressor/decompressor 105, stored as moving pictures A1 in memory 106, and displayed sequentially on display unit 113 during period 418. When the user instructs the apparatus to stop the reproducing through operating operation unit 110 at time point 404, recording/reproducing unit 107 stops the reading of the compressed moving picture data from hard disk 108, having period 416 terminate. Magnetic head 205 is positioned at magnetic disk 201 during periods 410 to 416 when the compressed moving picture data are reproduced from hard disk 108.

FIG. 4B shows an operation of recording/reproducing apparatus 1001 when still picture data are reproduced from hard disk 108. A user turns on recording/reproducing apparatus 1001 at time point 430 and turns it off at time point 437. The user operates recording/reproducing apparatus 1001 between time point 430 and time point 437. The user instructs the apparatus to reproduce still picture data through operation unit 110 at time point 431 while looking at information displayed on display unit 113. Recording/reproducing unit 107 reads out a predetermined amount of compressed still picture data corresponding to plural still pictures including a still picture to be reproduced from hard disk 108, and stores the data in memory 106. Controller 109 reads the compressed still picture data stored in memory 106, instructs compressor/decompressor 105 to decompress the compressed still picture data to provide still pictures, and stores the still pictures in memory 106. Controller 109 instructs display unit 113 to display the provided still pictures during period 442. When the user instructs the changing (frame-by-frame advance) of still pictures to be reproduced at time points 432 to 433 through operation unit 110, controller 109 instructs display unit 113 to display the still pictures stored in memory 106 during periods 443 to 444, respectively. Memory 106 stores a predetermined numbers of the still pictures to be displayed during periods 442 to 444. When the user instructs the apparatus to reproduce another still picture through operation unit 110 at time point 434, controller 109 allows recording/reproducing unit 107 to read out a predetermined amount of compressed still picture data from hard disk 108 and to store the data in memory 106. Compressor/decompressor 105 reads the compressed still picture data from memory 106, decompresses the data so as to provide still pictures, and stores the still pictures in memory 106. Controller 109 allows display unit 113 to display a still picture of the still pictures stored in memory 106 during period 445. When the user instructs changing of the still picture to be reproduced through operation unit 110 at time point 435 and 436, controller 109 allows display unit 113 to display the still pictures stored in memory 106 during periods 446 and 447, respectively. Magnetic head 205 is positioned at magnetic disk 201 during periods 440 and 441 when the compressed still picture data are reproduced from hard disk 108.

The amount of data of moving picture A1 is larger than that of still pictures, and the total of periods 410 to 416 is longer than the total of periods 440 and 441. That is, the time during which magnetic head 205 is positioned at magnetic disk 201 to record moving picture A1 is longer the time during which magnetic head 205 is positioned at magnetic disk 201 to reproduce still pictures.

An operation of magnetic head 205 of hard disk 108 will be described below. When recording/reproducing apparatus 1001 does not operate, magnetic head 205 is positioned at escape zone 206 that is not affected by vibration. As shown in FIG. 5, region 501 of magnetic disk 201 in which compressed moving picture data are recorded is closer to escape zone 206 than region 502 in which compressed still picture data are recorded. Consequently, the time during which magnetic head 205 moves between magnetic disk 201 and escape zone 206 to record and reproduce moving picture A1 is shorter than the time during which magnetic head 205 moves between magnetic disk 201 and escape zone 206 to record and reproduce still pictures. Thus, when receiving shock accompanying vibration or drop, the apparatus reduces the average time for allowing magnetic head 205 to escape from magnetic disk 201 to escape zone 206. Therefore, even if shock is very strong or the time to collision is very short, and even if the time from the start of the escape of magnetic head 205 until the shock transmitted to magnetic head 205 or magnetic disk 201 is short, the possibility of protecting magnetic disk 201 from shock increases, thus enhancing the shock resistant property of recording/reproducing apparatus 1001.

Recording/reproducing apparatus 1001 in accordance with Embodiment 1 records and reproduces moving picture A1 and still pictures. Recording/reproducing apparatus 1001 may records and reproduce signals, such as sound, having smaller data amount than that of moving picture A1 instead of still pictures, providing the same effect.

In FIG. 5, escape zone 206 is positioned outside magnetic disk 201. The moving picture data are recorded in region 501 near the outer circumference of magnetic disk 201 close to escape zone 206, and the still picture data are recorded in region 502 close to the inner circumference of magnetic disk 201 which is farther from escape zone 206 than region 501. If the escape zone is located inside the inner circumference of magnetic disk 201, the moving picture data are recorded in region 502 near the inner circumference of magnetic disk 201 close to the escape zone, and the still picture data are recorded in region 501 which is close to the outer circumference of magnetic disk 201 and farther from the escape zone than region 501. The moving picture data are recorded in a region (the inner portion or the outer portion of magnetic disk 201) close to an escape zone, and the still picture data are recorded in a region (the inner portion or the outer portion of magnetic disk 201) far from the escape zone, providing the same effects.

### Exemplary Embodiment 2

A recording/reproducing apparatus in accordance with Exemplary Embodiment 2 of the present invention includes magnetic disk 1201 shown in FIG. 6 instead of magnetic disk 201 as a recording medium of hard disk 108 shown in FIG. 5 of recording/reproducing apparatus 1001 in accordance with Embodiment 1 shown in FIGS. 1 and 2. The configurations other than the recording/reproducing apparatus in accordance with Embodiment 2 are the same as those of Embodiment 1, and description thereof is omitted.

When an operation mode switch of operation unit 110 is in a moving picture recording mode, controller 109 detects that a menu switch of operation unit 110 is pressed, and then, a setting menu about the recording of moving pictures is displayed on display unit 113. A user can set a compression ratio or a bit rate of compressed moving picture data for recording moving pictures through operation unit 110 while looking at the setting menu. According to Embodiment 2, one bit rate is selected from two of bit rates, i.e., a higher bit rate and a lower bit rate, through a four-direction switch and a determination switch of operation unit 110. The bit rate may be selected from more than two bit rates.

Upon detecting that the higher bit rate is selected and that a picture recording switch of operation unit 110 is pressed, controller 109 allows the moving picture to be recorded at the higher bit rate. Compressor/decompressor 105 multiplexes and compresses images and sound at the higher bit rate in a moving picture compression format, such as MPEG2, as to provide compressed moving picture data. The compressed moving picture data is temporarily stored in memory 106. The other operations are the same as those of recording/reproducing apparatus 1001 in accordance with Embodiment 1, and the description thereof is omitted.

Upon detecting that the lower bit rate is selected and the picture recording switch of operation unit 110 is pressed, controller 109 allows the moving picture to be recorded at the lower bit rate. Compressor/decompressor 105 multiplexes and compresses images and sound at the lower bit rate in a moving picture compression format, such as MPEG2, as to provide compressed moving picture data. The compressed moving picture data is temporarily stored in memory 106. The other operations are the same as those of recording/reproducing apparatus 1001 in accordance with Embodiment 1, and the description thereof is omitted.

With reference to FIG. 6, an operation of the recording/reproducing apparatus 1001 in accordance with Embodiment 2 will be described below. FIG. 6 is a plan view of magnetic disk 1201 of hard disk 108 of the recording/reproducing apparatus 1001 in accordance with Embodiment 2. Magnetic disk 1201 has regions 601 and 602 thereon. Region 601 is closer to escape zone 206 than region 602. Recording/reproducing unit 107 records compressed moving picture data at the higher bit rate in region 601 closer to escape zone 206 on magnetic disk 1201. Furthermore, recording/reproducing unit 107 records compressed moving picture data at the lower bit rate, which has an attribute different from that of the compressed data of the higher bit rate, in region 602 farther from escape zone 206 on magnetic disk 1201. Therefore, when recording/reproducing unit 107 reproduces the compressed moving picture data of the higher bit rate recorded in hard disk 108, the data are read from region 601 closer to escape zone 206 on magnetic disk 1201. Furthermore, when recording/reproducing unit 107 reproduces the compressed moving picture data of the lower rate recorded in hard disk 108, the data are read from region 602 farther from escape zone 206 on magnetic disk 1201.

The distance between escape zone 206 and region 601 of magnetic disk 1201 in which the compressed moving picture data of the higher rate are recorded is shorter than the distance between escape zone 206 and region 602 in which the compressed moving picture data of the lower rate are recorded. Therefore, the time during which magnetic head 205 moves to escape zone 206 to record and reproduce the compressed moving picture data of the higher rate can be shorter than the time during which magnetic head 205 moves to escape zone 206 to record and reproduce the compressed moving picture data of the lower rate.

With reference to FIG. 3A and FIG. 4A, an operation of the recording/reproducing apparatus 1001 in accordance with Embodiment 2 will be described in detail below.

With reference to FIG. 3A, an operation of the recording/reproducing apparatus 1001 in accordance with embodiment 2 recording moving picture Al and moving picture B1 having a bit rate lower than that of moving picture A1 will be described. In the recording/reproducing apparatus 1001 in accordance with embodiment 2, for example, a compression ratio of the compressed moving picture data of moving picture B1 is larger than that of moving picture A1, a frame rate of moving picture B1 is smaller than that of moving picture A1, or the number of pixels of moving picture B1 is smaller than that of moving picture A1. A user turns on recording/reproducing apparatus 1001 at time point 300 and turns it off at time point 305. The user starts the recording of moving picture A1 and moving picture B1 at time point 301, and stops the recording at time point 302. The user restarts the recording of moving picture A1 and moving picture B1 at time point 303, and stops at time point 304. when a predetermined amount of the compressed moving picture data of moving picture A1 are stored in memory 106 during period 310, the data in memory 106 are recorded in hard disk 108 during periods 312 to 313. Data remaining in memory 106 at time point 302 when the recording is stopped are recorded in hard disk 108 during period 314. when a predetermine amount of compressed moving picture data are stored in memory 106 during period 311, the data in memory 106 are recorded in hard disk 108 during periods 315 to 317. Data remaining in memory 106 at time point 304 when the recording is stopped are recorded in hard disk 108 during period 318. During periods 312 to 318 when the compressed moving picture data are recorded in hard disk 108, magnetic head 205 is positioned at magnetic disk 1201.

In order to record moving picture B1 having the bit rate lower than that of moving picture A1, a user starts the recording of moving picture B1 at time point 301 and stops the recording at time point 302. The user restarts the recording of moving picture B1 at time point 303 and stops the recording at time point 304. When a predetermined amount of compressed moving picture data of a predetermined amount of moving picture B1 are stored in memory 106, the data in memory 106 are recorded in hard disk 108 during periods 322 to 323. At time point 302 when the recording of moving picture B1 is stopped, no data remains in memory 106. When a predetermined amount of compressed moving picture data are stored in memory 106, the data in memory 106 are recorded in hard disk 108 during periods 324 to 325. Data remaining in memory 106 at time point 304 when the recording is stopped are recorded in hard disk 108 during period 326. During periods 322 to 326 when the compressed moving picture data are recorded in hard disk 108, magnetic head 205 is positioned at magnetic disk 1201.

Since the amount of the data of moving picture A1 having the bit rate higher than a bit rate of moving picture B1 is larger than the amount of the data of moving picture B1, the total of periods 312 to 318 is longer than the total of periods 322 to 326. That is, the time during which magnetic head 205 is positioned at magnetic disk 1201 to record moving picture A1 having the bit rate higher than that of moving picture B1 is longer than the time during which when magnetic head 205 is positioned at magnetic disk 1201 to record moving picture B1.

With reference to FIG. 4A, an operation of the recording/reproducing apparatus 1001 reproducing moving picture A1 and moving picture B1 having the bit rate lower than that of moving picture A1 in accordance with Embodiment 2 will be described below. A user turns on recording/reproducing apparatus 1001 at time point 400 and turns it off at time point 405. The user starts the reproducing of moving picture A1 at time point 401 and stops the reproducing at time point 402. Then, the user restarts the reproducing of moving picture A1 at time point 403 and stops the reproducing at time point 404. A predetermined amount of compressed moving picture data of moving picture A1 are read from hard disk 108 during periods 410 to 412 and are stored in memory 106. At time point 402 when reproduction of moving picture A1 is stopped, no data is read from hard disk 108. The compressed moving picture data stored in money 106 are decompressed by compressor/decompressor 105 so as to provide moving picture data. The moving picture data are stored in memory 106. The moving picture data of moving picture A1 stored in memory 106 is sequentially displayed on display unit 113 during period 417. When the reproduction of moving picture A1 restarts at time point 403, compressed moving picture data read from hard disk 108 during periods 413 to 416 are stored in memory 106. The compressed moving picture data stored in memory 106 are decompressed by compressor/decompressor 105 and stored in memory 106 as moving picture data. The moving picture data stored in memory 106 is sequentially displayed on display unit 113 during period 418. At time point 404 when the reproduction is stopped, recording/reproducing unit 107 stops the reading of the compressed moving picture data from hard disk 108, and period 416 is terminated. During periods 410 to 416 when the compressed moving picture data read from hard disk 108, magnetic head 205 is positioned magnetic disk 1201.

When moving picture B1 having a bit rate lower than that of moving picture A1 is reproduced, a predetermined amount of compressed moving picture data are read from hard disk 108 during periods 420 to 421 and are stored in memory 106. At time point 402 when the reproduction of moving picture B1 is stopped, no data is read from hard disk 108. The compressed moving picture data are decompressed by compressor/decompressor 105 to provide moving picture data, and the moving picture data are stored in memory 106. The moving picture data of moving picture B1 stored in memory 106 is sequentially displayed on display unit 113 during period 425. After the reproducing of moving picture B1 restarts at time point 403, compressed moving picture data are read from hard disk 108 during periods 422 to 424 and are stored in memory 106. The compressed moving picture data stored in memory 106 are decompressed by compressor/decompressor 105 and stored in memory 106 as moving picture data. The moving picture data stored in memory 106 is sequentially displayed on display unit 113 during period 426. At time point 404 when the reproduction is stopped, recording/reproducing unit 107 stops the reading of the compressed moving picture data read from hard disk 108 during period 424 are stored in memory 106 at time point 404 when the reproducing is stopped. During periods 420 to 424 when the compressed picture data are read from hard disk 108, magnetic head 205 is positioned at magnetic disk 1201.

Since the amount of data of moving picture A1 having the higher bit rate is larger than the amount of data of moving picture B1 having a bit rate lower than the bit rate of moving picture A1, the total of periods 410 to 416 is longer than the total of periods 420 to 424. That is, the time during which magnetic head 205 is positioned at magnetic disk 1201 to reproduce moving picture A1 having the higher bit rate is longer than the time during which magnetic head 205 is positioned at magnetic disk 1201 to reproduce moving picture B1 having the bit rate lower than that of moving picture A1.

As shown in FIG. 6, region 601 of magnetic disk 1201 in which compressed moving picture data of moving picture A1 having the higher bit rate are recorded is closer to escape zone 206 than region 602 in which compressed moving picture data of moving picture B1 having the lower bit rate are recorded. Consequently, the time during which magnetic head 205 moves from magnetic disk 1201 to escape zone 206 while accessing data of moving picture A1 having the higher bit rate is shorter than the time during which magnetic head 205 moves from magnetic disk 1201 to escape zone 206 while accessing data of moving picture B1 having the lower bit rate. Thus, the apparatus can reduce the average time of moving magnetic head 205 from magnetic disk 1201 to escape zone 206 when receiving shock accompanying vibration or drop. Therefore, even if the shock is very strong or even if the time to collision is very short so that the time period from the start of moving of magnetic head 205 to escape zone 206 until the shock is transmitted to magnetic head 205 or magnetic disk 1201 is short, the possibility of protecting magnetic disk 1201 from the shock increases, thus enhancing the shock resistant property of recording/reproducing apparatus.

According to Embodiment 2, moving picture A1 having the higher bit rate is recorded in region 601 of magnetic disk 1201, and moving picture B1 having the bit rate lower than that of moving picture A1 is recorded in region 602 farther to escape zone 206 than region 601. Besides the above data, data causing magnetic head 205 to be located at magnetic disk 1201 for a long time period for accessing the data are recorded in region 601, and data causing magnetic head 205 to be located at magnetic disk 1201 for a short time period for accessing the data are recorded in region 602, providing the same effects. Furthermore, data to be reproduced more often may be recorded in region 601, and data to be reproduced less often may be recorded in region 602, providing the same effects.

In FIG. 6, escape zone 206 is positioned outside magnetic disk 1201. The moving picture data of moving picture A1 having the higher bit rate are recorded in region 601 near the outer circumference of magnetic disk 1201 close to escape zone 206, and the moving picture data of moving picture B1 having the bit rate lower than that of moving picture A1 are recorded in region 602 close to the inner circumference of magnetic disk 1201 which is farther from escape zone 206 than region 601. If the escape zone is located inside the inner circumference of magnetic disk 1201, the moving picture data of moving picture A1 are recorded in region 602 near the inner circumference of magnetic disk 1201 close to the escape zone, and the moving picture data of moving picture B1 are recorded in region 601 which is close to the outer circumference of magnetic disk 1201 and farther from the escape zone than region 601. Moving picture A1 is recorded in a region (the inner portion or the outer portion of magnetic disk 201) close to the escape zone, and moving picture B1 is recorded in a region (the inner portion or the outer portion of magnetic disk 201) far from the escape zone, providing the same effects.

What is claimed is:

1. A recording/reproducing apparatus comprising:
a disk recording medium;
a head for accessing the disk recording medium;
an escape zone to which the head escapes;
a controller operable to control the head as to
record first data in a first region of the disk recording medium with the head, and
record second data in a second region of the disk recording medium with the head, the second region being located farther from the escape zone than the first region, the second data having an attribute different from an attribute of the first data;
a sensor for detecting vibration or drop of the disk recording medium; and
an actuator for moving the head from the disk recording medium to the escape zone based on a detection result of the sensor.

2. The recording/reproducing apparatus according to claim 1,
wherein the first data comprises moving picture data, and
wherein the second data comprises still picture data.

3. The recording/reproducing apparatus according to claim 1,
wherein the first data comprises moving picture data compressed at a first bit rate, and
wherein the second data comprises moving picture data compressed at a second bit rate lower than the first bit rate.

4. A method of protecting a disk recording medium, comprising:
recording first data in a first region of a disk recording medium with a head;
recording second data in a second region of the disk recording medium with the head, the second region being located farther from an escape zone than the first region, the second data having an attribute different from an attribute of the first data; and
moving the head from the disk recording medium to the escape zone according to an detection result of a sensor for detecting vibration of the disk recording medium.

5. The method according to claim 4,
wherein the first data comprises moving picture data; and
wherein the second data comprises still picture data.

6. The method according to claim 4,
wherein the first data comprises moving picture data compressed at a first bit rate, and
wherein the second data comprises moving picture data compressed at a second bit rate lower than the first bit rate.
